(19) United States
(12) Patent Application Publication
(10) Pub. No.: US 2011/0051352 A1
(43) Pub. Date: Mar. 3, 2011

(54) Stacking-Type USB Memory Device And Method Of Fabricating The Same

(76) Inventors: Gyu Han Kim, Chungcheongnam-do (KR); Tae Hyun KIM, Chungcheongnam-do (KR)

(21) Appl. No.: 12/874,019

(22) Filed: Sep. 1, 2010

(30) Foreign Application Priority Data
Sep. 2, 2009 (KR) 10-2009-0082574
Sep. 2, 2009 (KR) 10-2009-0082575

(51) Int. Cl. G06F 1/16

(52) U.S. Cl. 361/679.31

(57) ABSTRACT

Provided is a stacking type universal serial bus (USB) memory device that can reduce the size of the stacking type USB memory device by mounting semiconductor chips in a recess region formed in a substrate and a method of fabricating the same. The stacking type USB memory device includes a substrate that includes a recess region; at least one passive electronic element mounted in the recess region; at least one control semiconductor chip mounted in the recess region; at least one semiconductor memory chip mounted on a first surface of the substrate so as to overlap the at least one passive electronic element, at least one control semiconductor chip, or both of them; and an external wire pattern formed on a second surface of the substrate facing the first surface thereof.

### CROSS-REFERENCE TO RELATED APPLICATIONS

The present application claims priority of Korean Patent Application No. 10-2009-0082574, filed on Sep. 2, 2009, and Korean Patent Application No. 10-2009-0082575, filed on Sep. 2, 2009, the content of which is incorporated herein in its entirety by reference.

### FIELD OF THE INVENTION

The present invention relates to a universal serial bus (USB) memory device and a method of fabricating the same, and more particularly, to a stacking type USB memory device that can reduce size by mounting semiconductor chips in a recess region formed in a substrate and a method of fabricating the same.

### BACKGROUND OF THE INVENTION

In the modern society, a computing device is an essential means for managing a large amount of information. Recently, as the performance of hardware of the computing device is improved, the size of data or programs used by the user in the computing device is rapidly increased. In this way, the developed technique for fabricating a semiconductor enables high integration of a memory device, and thus, a mobile storage device, for example a USB memory device having a large capacity is generalized. Such USB memory devices are widely used in that it is easy to carry and a large amount of information can be reliably transmitted to others. However, in a conventional USB memory device, since memory chips and control chips are mounted together on a plane of a substrate, there is a limit in reducing an overall size of the device.

### SUMMARY OF THE INVENTION

To address the above and/or other problems, the present invention provides a stacking type USB memory device that can reduce a size of a device by mounting semiconductor chips in a recessed region formed in a substrate.

The present invention also provides a method of fabricating a stacking type USB memory device that can reduce a size of a device by mounting semiconductor chips in a recessed region formed in a substrate.

According to an aspect of the present invention, there is provided a stacking type universal serial bus (USB) memory device comprising: a substrate that includes a recess region; at least one passive electronic element mounted in the recess region; at least one control semiconductor chip mounted in the recess region; at least one semiconductor memory chip mounted on a first surface of the substrate so as to overlap the at least one passive electronic element, the at least one control semiconductor chip, or both of them; and an external wire pattern formed on a second surface of the substrate facing the first surface thereof.

The stacking type USB memory device may further comprise a sealing member that seals the at least one semiconductor memory chip.

The recess region may further comprise a first wire pattern therein, and the at least one control semiconductor chip may be electrically connected to the first wire pattern through a first connection member.

The first connection member may comprise at least one selected from the group consisting of a bonding wire, a solder ball, a flip-chip bonding member, a bump, or a conductive via.

The first connection member may have a height so as not to protrude from the height of the recess region.

The substrate may further comprise a second wire pattern on the first surface thereof. The at least one semiconductor memory chip may be electrically connected to the second wire pattern through a second connection member.

The second connection member may comprise at least one selected from the group consisting of a bonding wire, a solder ball, a bump, or a conductive via.

The substrate may comprise a plurality of recess regions.

The passive electronic element and the at least one control semiconductor chip may be mounted in the recess regions different from each other.

The substrate may have a multi-layered structure, and may be formed of epoxy resin, polyimide resin, bismaleimide triazine (BT) resin, flame retardant 4 (FR-4), ceramic, silicon, or glass

The at least one semiconductor memory chip may be a semiconductor die or a semiconductor package, and may be a NAND flash memory, a phase-change random access memory (PRAM), a resistive RAM (RRAM), a ferroelectric RAM (FeRAM), or a magnetic RAM (MRAM).

The stacking type USB memory device may further comprise a case that surrounds the substrate by exposing the external wire pattern.

According to another aspect of the present invention, there is provided a stacking type USB memory device of claim comprising: a substrate that comprises at least one recess region; at least one passive electronic element mounted in the recess region; at least one control semiconductor chip mounted in the recess region; at least one functional semiconductor chip mounted in the recess region; at least one semiconductor memory chip mounted on a first surface of the substrate so as to overlap the passive electronic element, the control semiconductor chip, the functional semiconductor chip, or all of them; and an external wire pattern formed on a second surface of the substrate facing the first surface thereof.

The recess region may further comprise a first wire pattern therein, and the at least one control semiconductor chip, the at least one functional semiconductor chip, and both of them may be electrically connected to the first wire pattern through a first connection member.

The first connection member may comprise at least one selected from the group consisting of a bonding wire, a solder ball, a bump, a flip-chip bonding member, or a conductive via.

The first connection member may have a height so as not to protrude from the height of the recess region.

The at least one functional semiconductor chip may comprise a wireless local area network (WLAN) semiconductor chip or a subscriber identity module (SIM) semiconductor chip.

The at least one passive electronic element, the at least one control semiconductor chip, and the at least one functional semiconductor chip may be mounted in the recess regions different from each other.

According to an aspect of the present invention, there is provided a method of fabricating a stacking type USB memory device, the method comprising: providing a substrate that comprises a recess region and an external wire pattern; mounting at least one passive electronic element, at least one control semiconductor chip, or both of them in the recess region; and mounting at least one semiconductor memory chip on a first surface of the substrate so as to overlap the at least one passive electronic element and the at least one control semiconductor chip.

The method may further comprise sealing the at least one memory semiconductor chip.

The providing of the substrate may further comprise forming a recess region by mechanically processing or chemically etching the substrate. Also, the providing of the substrate may further comprise combining a plurality of substrate members which are processed to form the recess region. The mounting of the at least one passive electronic element, the at least one control semiconductor chip, or both of them may comprise electrically connecting the at least one passive electronic element, the at least one control semiconductor chip, or both of them to a first wire pattern formed in the recess region. The mounting of the at least one memory semiconductor chip may comprise electrically connecting the at least one memory semiconductor chip to a second wire pattern formed in the substrate.

According to another aspect of the present invention, there is provided a method of fabricating a stacking type USB memory device, the method comprising: providing a substrate that comprises at least one passive electronic element and an external wire pattern; mounting the at least one passive electronic element, the at least one control semiconductor chip, the at least one functional semiconductor chip, or all of them in the recess region; and mounting at least one memory semiconductor chip on a first surface of the substrate so as to overlap the at least one passive electronic element, the at least one control semiconductor chip, the at least one functional semiconductor chip, or all of them.

The mounting of the at least one passive electronic element, the at least one control semiconductor chip, the at least one functional semiconductor chip, or all of them may comprise electrical connecting the at least one passive electronic element, the at least one control semiconductor chip, the at least one functional semiconductor chip, or all of them to a first wire pattern formed in the recess region. Also, the mounting of the at least one memory semiconductor chip may comprise electrical connecting the at least one memory semiconductor chip to a second wire pattern formed on the substrate.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are block diagrams showing a connection between a host and a stacking type USB memory device according to an embodiment of the present inventive concept;

FIG. 2 is a schematic drawing showing a connection unit of FIGS. 1A and 1B;

FIG. 3 is a cross sectional view of the stacking type USB memory device according to an embodiment of the present inventive concept;

FIGS. 4A through 4E are cross-sectional views showing processes of fabricating a stacking type USB memory device according to an embodiment of the present inventive concept;

FIGS. 5 through 7 are cross-sectional views of a stacking type USB memory device according to an embodiment of the present inventive concept;

FIG. 8 is a cross-sectional view of a stacking type USB memory device according to another embodiment of the present inventive concept;

FIGS. 9A through 9E are cross-sectional views showing processes of fabricating a stacking type USB memory device according to another embodiment of the present inventive concept;

FIGS. 10 through 13 are cross-sectional views of a stacking type USB memory device according to an embodiment of the present inventive concept; and

FIGS. 14A and 14B are cross-sectional views of substrates having a plurality of recess regions according to another embodiment of the present inventive concept.

### DETAILED DESCRIPTION OF THE INVENTION

Reference will now be made in detail to exemplary embodiments, examples of which are illustrated in the accompanying drawings. However, exemplary embodiments are not limited to the embodiments illustrated hereinafter, and the embodiments herein are rather introduced to provide easy and complete understanding of the scope and spirit of exemplary embodiments. In the drawings, the thicknesses of layers and regions are exaggerated for clarity.

It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of exemplary embodiments.

Spatially relative terms, such as “above,” “upper,” “beneath,” “below,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “above” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but may be to include deviations in shapes that result, for example, from manufacturing. For example, an implanted region illustrated as a rectangle may, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes may be not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the exemplary embodiments of the inventive concept will be described in detail with reference to the accompanying drawings. In the drawings, variations from the shapes of the illustrations as a result, for example, of manufacturing techniques and/or tolerances, are to be expected. Thus, the example embodiments should not be construed as limited to the particular shapes of regions illustrated herein but may be to include deviations in shapes that result, for example, from manufacturing.

A universal serial bus (USB) memory device is an interface developed to address inconvenience of slow speed of conventional external extension port which is a kind of direct ports and connecting limited devices. Generally, a USB system includes a USB host and a USB memory device, and all of the USB devices are connected to the USB host, that is, conventionally a personal computer. The USB memory device works when the USB memory device is connected to a host, and when the USB memory device is connected to an interface provided for USB in the host, the host provides list of files stored in the USB memory device to the user, and thus, the user can run a desired file. The USB system allows peripherals such as key board, monitor, mouse, printer, or modem, which are connected to the host in different methods in the prior art, to be connected at once using the same method, and even, as many as 127 peripherals can be connected. When a new peripheral is connected to the host, the host can automatically recognizes the USB memory device without the need for setting up or a rebooting, and a plug and play (PnP) is completely supported.

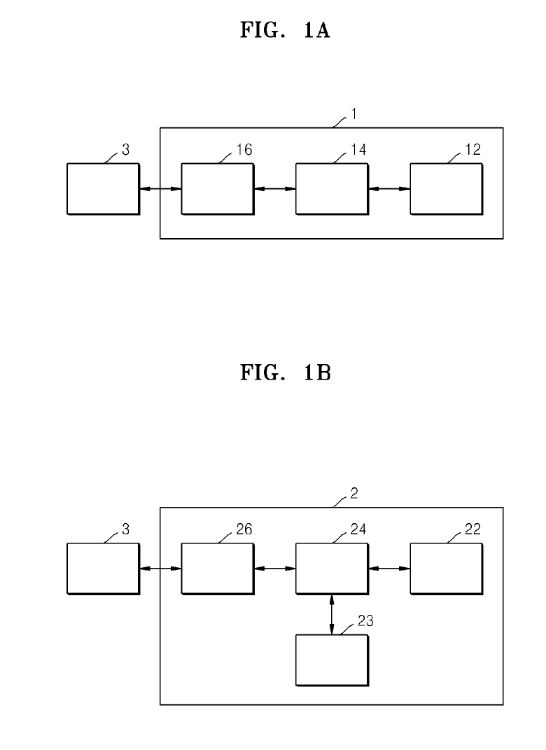

FIGS. 1A and 1B are block diagrams showing a connection between a host 3 and stacking type USB memory devices 1 and 2 according to an embodiment of the present inventive concept.

Referring to FIG. 1A, the stacking type USB memory device 1 includes a memory unit 12, a control unit 14, and a connection unit 16. The memory unit 12 stores data and may include a non-volatile memory, for example, a flash memory that can maintain data when power is turned off. The control unit 14 controls the access to the data stored in the memory unit 12. The control unit 14 may be an additional control semiconductor chip such as an application specific integrated circuit (ASIC) or a control program stored in a system region of the memory unit 12. The control unit 14 may be designed to run automatically by an operating system of the host 3, for example, when the stacking type USB memory device 1 is connected to the host 3. In this case, the control unit 14 may include a script for automatically running and an application program that can be run in the host 3. The connection unit 16 connects the stacking type USB memory device 1 to the host 3. For example, the connection unit 16 may be electrically connected to the host 3 by being inserted into a socket unit (not showing) of the host 3 or through an additional reading device (not showing). When the stacking type USB memory device 1 is connected to the host 3 through the connection unit 16, enumeration is performed. The enumeration is a process of determining the endpoint type, numbers, or kind of products of the stacking type USB memory device 1 by the host 3. Thus, the host 3 allocates an address to the stacking type USB memory device 1 and prepares for transmitting data by taking a device descriptor and a configuration descriptor from the stacking type USB memory device 1.

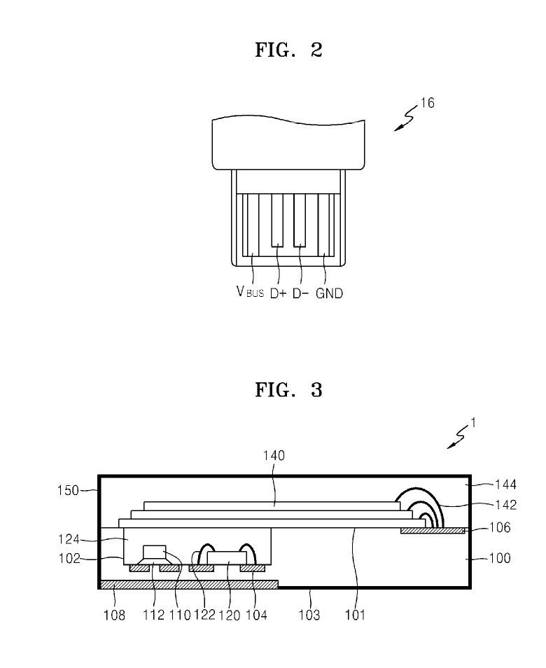

Referring to FIG. 1B, the stacking type USB memory device 2 includes a memory unit 22, a control unit 24, a functioning unit 23, and a connection unit 26. When the stacking type USB memory devices 1 and 2 of FIGS. 1A and 1B are compared, the stacking type USB memory device 2 of FIG. 2 further includes the functioning unit 23. To make clarity of the present inventive concept, the descriptions of like element will not be repeated.

The functioning unit 23 can perform multiple functions, for example, the functions of wireless local area network (WLAN) or subscriber identity module (SIM).

When the functioning unit 23 functions as a WLAN function, that is, as a wireless LAN communication between systems such as computers, the functioning unit 23 may include a USB/PCMCIA transformation control unit (not shown) for mutually transforming data according to a USB interface protocol and data according to a PCMCIA interface protocol, a base band unit (not showing) that transforms data received from the USB/PCMCIA transformation unit or restores transformed data, and an antenna unit (not showing) that transmits data received from the base band by processing to a high frequency signal, and also, receives high frequency signals. The functioning unit 23 that performs the WLAN function can input and output high frequency signals with an external LAN communication hub, a RFID tag, a non-contact IC card, a personal digital assistant (PDA), or a non-contact USB device without a wire.

When the functioning unit 23 functions as a SIM function, required information such as subscriber information can be stored in the functioning unit 23, and when the stacking type USB memory device 2 is connected to a terminal such as a mobile phone, the terminal can be compatibly used as a terminal of the user using the subscriber information stored in the functioning unit 23. Also, the functioning unit 23 may realize a USIM function that performs as a general-use IC card function such as a transportation card function or a credit card function in addition to the SIM function.

The control unit 24 can control the operation of the functioning unit 23, can transmit data stored in the memory unit 22 to the functioning unit 23, and can transmit data received from the functioning unit 23 to the memory unit 22 to store in the memory unit 22.

FIG. 2 is a schematic drawing showing the connection units 16 and 26 of FIGS. 1A and 1B.

Referring to FIG. 2, the connection units 16 and 26 may include a power line V_{BUS}, a ground line GND, and a pair of data lines D+ and D−. The power line V_{BUS} is connected to a power supply source, the ground line GND is connected to a ground power source. Power supplied to the stacking type USB memory devices 1 and 2 may be, for example, a voltage of 3 to 5V and a current of 100 to 500 mA. The pair of data lines D+ and D− transmits data. Through the data lines D+ and D−, serial data and reversed serial data that is reversed from the serial data are respectively transmitted. In this way, the synchronous transmission of the serial data and reversed serial data can minimize the generation of noise that can be generated when data are transmitted. Also, the power line V_{BUS} and the ground line GND can have a length greater than that of the data lines D+ and D−. Accordingly, when the connection units 16 and 26 are connected to the host 3, the power line V_{BUS} and the ground line GND are connected in advance, and after the power is supplied, the data lines D+ and D− are connected. However, when the connection units 16 and 26 are disconnected from the host 3, the power line V_{BUS} and the ground line GND are disconnected after the data lines D+ and D− are disconnected, and thus, power is turned off. The structure of connection prevents the stacking type USB memory devices 1 and 2 from an electrical impact. The connection units 16 and 26 may be a conventional A type plug (female type) USB terminal, a B type plug (male type) USB terminal, or a mini plug type USB terminal. The stacking type USB memory device 1 may be a USB 1.1 having a transmission speed of maximum 12 Mbps or a USB 2.0 having a transmission speed of 480 Mbps. Also, the connection units 16 and 26 may be a 24 pin input/output terminal used for mobile phones or a combined 20 pin input/output terminal used for mobile phones. However, the shapes, functions, and kinds of the connection units 16 and 26 described above are examples and the present inventive concept is not limited thereto.

In the current inventive concept, a USB flash drive is described to explain the stacking type USB memory devices 1 and 2 according to an embodiment of the present inventive concept. However, the USB flash drive is an example, and thus, the present invention is not limited thereto. For example, the stacking type USB memory devices 1 and 2 may be a kind of memory among various memory cards, and, for example, may be a memory card that includes PC card (PCMCIA), compact flash (CF), smart media (SM/SMC), memory stick (MS), memory stick duo (MSD), multimedia card (MMC), secure digital card (SD), mini SD card, micro SD card, xD-picture card. The host 3 described in the present inventive concept may include all kind of devices including a computing unit, a memory unit, a control unit, and an input/output unit, and, for example, may be a computer, a personal computer, a portable computer, a PDA, a mobile phone, an MP3 player, a navigation, or a portable multimedia player (PMP).

FIG. 3 is a cross-sectional view of a stacking type USB memory device 1 according to an embodiment of the present inventive concept.

Referring to FIG. 3, the stacking type USB memory device 1 includes a substrate 100, at least one passive electronic element 110, at least one control semiconductor chip 120, at least one memory semiconductor chip 140, and an external wire pattern 108. The passive electronic element 110 and the control semiconductor chip 120 are mounted on a recess region 102 of the substrate 100. The passive electronic element 110 is electrically connected to a first wire pattern 104 formed in the recess region 102 of the substrate 100 through a passive electronic element connection member 112. The control semiconductor chip 120 is electrically connected to the first wire pattern 104 formed in the recess region 102 of the substrate 100 through a first connection member 122. The memory semiconductor chip 140 is mounted on a first surface 101 of the substrate 100. In other words, the memory semiconductor chip 140 can be mounted on the recess region 102 so as to overlap the passive electronic element 110, the control semiconductor chip 120, or both of them, which are mounted in the recess region 102. The memory semiconductor chip 140 is electrically connected to a second wire pattern 106 formed on the substrate 100 through a second connection member 142. The passive electronic element 110 and the control semiconductor chip 120 are encapsulated by a first sealing member and the memory semiconductor chip 140 is encapsulated by a second sealing member 144. Optionally, a case 150 that surrounds the substrate 100 and the second sealing member 144 may further be included while exposing at least a portion of the external wire pattern 108.

In the stacking type USB memory device 1 according to an embodiment of the present inventive concept, the passive electronic element 110 and the control semiconductor chip 120 are mounted in a recess region 102 of the substrate 100 and the memory semiconductor chip 140 can be stacked on the recess region 102 so as to overlap the passive electronic element 110, the control semiconductor chip 120 or both of them. Accordingly, the size of the stacking type USB memory device 1 can be reduced. Also, the passive electronic element 110, the control semiconductor chip 120, or both of them can be mounted so as to overlap the external wire pattern 108, and thus, the size of the stacking type USB memory device 1 can further be reduced.

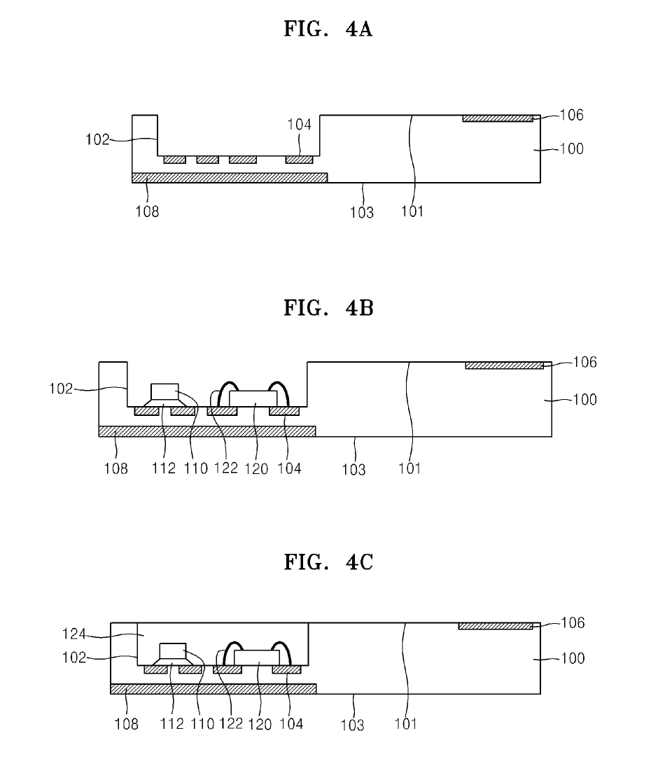

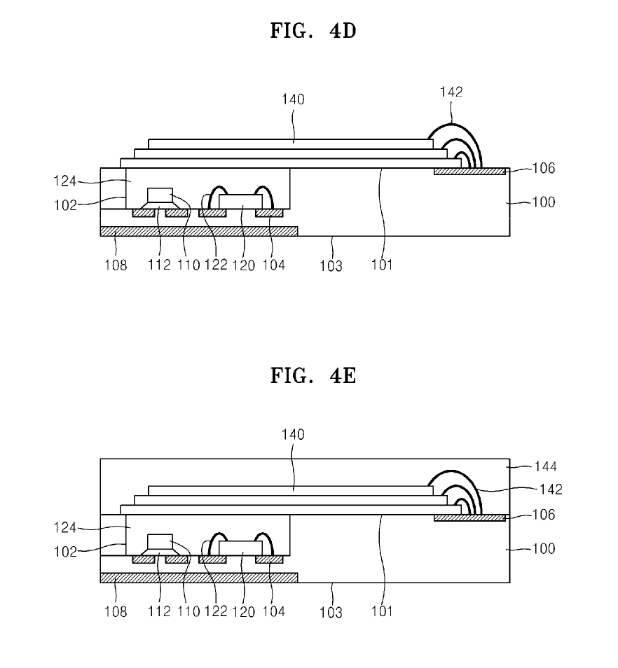

FIGS. 4A through 4E are cross-sectional views showing processes of fabricating a stacking type USB memory device 1 according to an embodiment of the present inventive concept.

Referring to FIG. 4A, a substrate 100 including a recess region 102 is provided. The substrate 100 includes a first wire pattern 104 formed in the recess region 102, a second wire pattern 106 formed on a first surface 101, and an external wire pattern 108 formed on a second surface 103 that faces the first surface 101.

The substrate 100 may be formed of epoxy resin, polyimide resin, bismaleimide triazine (BT) resin, flame retardant 4 (FR-4), FR-5, ceramic, silicon, or glass; however, these materials are examples, and thus, the materials according to the present inventive concept are not limited thereto. The substrate 100 may be a monolayer substrate or a substrate having a multi-layered structure of wire patterns. For example, the substrate 100 may be a single rigid substrate, a substrate formed by combining multiple rigid substrates, or a combined substrate in which thin flexible printed circuit boards (PCBs) and rigid substrates are combined. The multiple rigid substrates combined to each other or the PCBs that are combined to each other may respectively include wire patterns. Also, the substrate 100 may be a low temperature co-fired ceramic (LTCC) substrate. The LTCC substrate may be formed by stacking a plurality of ceramic layers and can include wire patterns therein. Also, the substrate 100 may be simultaneously formed with the recess region 102 using a molding method that uses a mold having a reversed shape to the recess region 102. Also, the recess region 102 may be formed by mechanically processing a portion of the substrate 100 or by chemically etching the substrate 100. Also, the recess region 102 may be formed by combining at least two substrate members (not showing). Also, more than two recess regions 102 may be formed in a single substrate 100.

As described above, the second wire pattern 106 is formed on the first surface 101 of the substrate 100 and the external wire pattern 108 is formed on the second surface 103 facing the first surface 101. Also, the first wire pattern 104 is formed in the recess region 102 of the substrate 100. The external wire pattern 108 is electrically connected to external devices. The external wire pattern 108 may correspond to the connection unit 16 of FIG. 1A, and may include, for example, a power line V_{BUS}, a ground line GND, and a pair of data lines D+ and D−. Although not shown, the first wire pattern 104, the second wire pattern 106, and the external wire pattern 108 may be electrically connected to each other through an electrical connection member, for example, conductive vias (not shown). Also, ad described above, the substrate 100 may be a multi-layered substrate that includes wire patterns therein, and the first wire pattern 104 and the second wire pattern 106 may be wire patterns formed in the substrate 100. Also, the first wire pattern 104, the second wire pattern 106, and the external wire pattern 108 may include a metal, for example, Cu, Al, Au, Ag, Pt, Ni, Pd, Ru, or an alloy of these metals. Also, the first wire pattern 104, the second wire pattern 106, and the external wire pattern 108 may be formed by stacking multiple layers, and a metal having a strong oxidation resistance, for example, Au can be coated on surfaces thereof; however, it is an example, and thus, the present invention is not limited thereto.

Referring to FIG. 4B, at least one passive electronic element 110 and at least one control semiconductor chip 120 are mounted in the recess region 102 of the substrate 100. The relative positions and the numbers of the passive electronic elements 110 and the control semiconductor chips 120 are examples, and thus, the present invention is not limited thereto. For example, the passive electronic element 110 and the control semiconductor chip 120 may be respectively multiple numbers, and may be disposed in the recess region 102 in an arrangement different from that of shown in FIG. 4B. Also, the passive electronic element 110 and the control semiconductor chip 120 may be respectively mounted in a plurality of recess regions 102 (not shown) that are separated from each other.

The passive electronic element 110 may be electrically connected to the first wire pattern 104 through a passive electronic element connection member 112. The passive electronic element connection member 112 may be, for example, a solder. The passive electronic element 110 may be a resistance element, an inductor element, a capacitor element, or a switch element, but not limited thereto.

The control semiconductor chip 120 may be electrically connected to the first wire pattern 104 through a first connection member 122. The first connection member 122 may have a height that does not protrude from the height of the recess region 102 of the substrate 100. The control semiconductor chip 120 may be attached to the recess region 102 of the substrate 100 using an adhesion member (not shown) such as a liquid adhesive or an adhesive tape. The control semiconductor chip 120 may correspond to the control unit 14 of FIG. 1A, may control communications between the stacking type USB memory device 1 and the host 3, and may control the operation of programming, reading, and erasing of data in the memory semiconductor chip 140. Also, the control semiconductor chip 120 may be a semiconductor chip die or a semiconductor package.

The first connection member 122 may be a bonding wire, and the bonding wire may be formed of Au, Ag, Cu, Al, or an alloy of these metals. The bonding wire may be formed using a conventional forward folded loop mode method or a reverse loop mode method. Also, the first connection member 122 is depicted in a bonding wire; however, it is an example, and thus, is not limited thereto. For example, the first connection member 122 may be a solder ball, a flip-chip bonding member, a bump, a conductive via, or a combination of these materials. Another embodiment of the first connection member 122 will be described later in detail.

Referring to FIG. 4C, a first sealing member 124 that buries the recess region 102 is formed. The first sealing member 124 seals the passive electronic element 110 and the control semiconductor chip 120. The first sealing member 124 protects the passive electronic element 110, the control semiconductor chip 120, the passive electronic element connection member 112, and the first connection member 122 from an external environment. The passive electronic element 110, the control semiconductor chip 120, and the first connection member 122 may not protrude from the first sealing member 124. The first sealing member 124 may be an encapsulant material, for example, an epoxy resin or a silicon resin; however, the encapsulant material according to the present are not limited thereto. Also, the fabrication of the first sealing member 124 is optional, and thus, the fabrication process thereof may be omitted, and may be simultaneously formed with a second sealing member 144 which will be described later.

Referring to FIG. 4D, at least one memory semiconductor chip 140 is mounted on the first surface 101 of the substrate 100. The memory semiconductor chip 140 is positioned to stack overlapping with the recess region 102 where the passive electronic element 110 and the control semiconductor chip 120 are mounted. Thus, at least one of the passive electronic element 110 and the control semiconductor chip 120 may be overlapped with the memory semiconductor chip 140. The memory semiconductor chip 140 may be electrically connected to the second wire pattern 106 through a second connection member 142. The memory semiconductor chip 140 may be attached to the first surface 101 of the substrate 100 using an adhesive member (not shown) such as a liquid adhesive or an adhesive tape. The memory semiconductor chip 140 may correspond to the memory unit 12 of FIG. 1A, may be a data storing device, and may be a non-volatile memory such as an NAND flash memory, a phase-change random access memory (PRAM), a resistive RAM (RRAM), a ferroelectric RAM (FeRAM), or a magnetic RAM (MRAM). Also, the memory semiconductor chips 140 may have sizes identical or different from each other. Also, the memory semiconductor chip 140 may be a semiconductor die or a semiconductor package. The kind, number, size, stacking method, and stacking shape of the memory semiconductor chip 140 shown in FIG. 4D are examples, and thus, are not limited thereto.

The second connection member 142 may be a bonding wire, and the bonding wire may be formed of Au, Ag, Cu, Al, or an alloy of these metals. In FIG. 4D, the second connection member 142 is depicted as a bonding wire; however, it is an example, and thus, is not limited thereto. For example, the second connection member 142 may be a solder ball, a flip-chip bonding member, a bump, or a conductive via. Another embodiment of the second connection member 142 will be described later in detail.

Referring to FIG. 4E, a second sealing member 144 is formed to seal the memory semiconductor chip 140. The memory semiconductor chip 140 and the second connection member 142 may not protrude from the second sealing member 144. The second sealing member 144 may be an encapsulant material, for example, an epoxy resin or a silicon resin; however, it is an example, and thus, the encapsulant material according to the present are not limited thereto. The second sealing member 144 protects the substrate 100, the memory semiconductor chip 140, and the second connection member 142 from an external environment. The first sealing member 124 and the second sealing member 144 may be formed of an identical member or different members from each other. When the first sealing member 124 is not formed, the recess region 102 may be also buried with the second sealing member 144, and accordingly, the passive electronic element 110 and the control semiconductor chip 120 may be sealed together with the memory semiconductor chip 140. As a result, the sum of heights of the substrate 100 and the second sealing member 144 is equal to the height of the connection unit 16 of FIG. 1A, and thus, may have a size that can be inserted into a receptacle (not shown) formed in the host 3 so that the connection unit 16 can be connected to the host 3.

Next, a case 150 may be formed to surround the substrate 100 and the second sealing member 144 by exposing at least a portion of the external wire pattern 108, and thus, the manufacture of the stacking type USB memory device 1 of FIG. 3 is completed. The case 150 may be formed of metal or polymer, and may protect the stacking type USB memory device 1 from external environment. In some cases, at least a portion of the case 150 may be omitted.

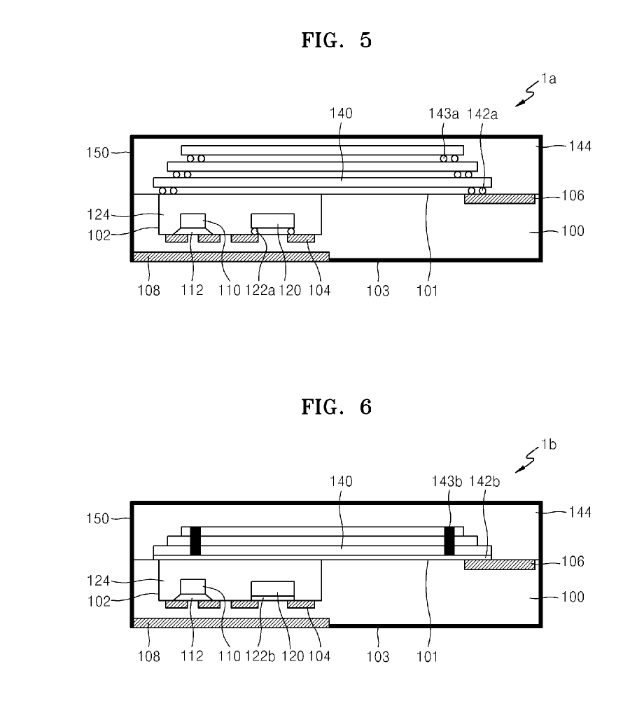

FIGS. 5 through 7 are cross-sectional views of stacking type USB memory devices 1a, 1b, and 1c according to an embodiment of the present inventive concept. For clarity of the present inventive concept, descriptions of elements which have described above will be omitted.

Referring to FIG. 5, the stacking type USB memory device 1a includes solder balls as a first connection member 122a and a second connection member 142a when compared to the stacking type USB memory device 1 of FIG. 3. Thus, the control semiconductor chip 120 is electrically connected to the first wire pattern 104 through the first connection member 122a which is a solder ball. Also, the memory semiconductor chip 140 is electrically connected to the second wire pattern 106 through the second connection member 142a which is a solder ball. Also, the memory semiconductor chips 140 may be electrically connected to each other by a third connection member 143a which is a solder ball.

Referring to FIG. 6, the stacking type USB memory device 1b includes flip chip bonding members as a first connection member 122b and a second connection member 142b when compared to the stacking type USB memory device 1 of FIG. 3. Thus, the control semiconductor chip 120 is electrically connected to the first wire pattern 104 by the first connection member 122b which is a flip chip bonding member. Also, the memory semiconductor chip 140 is electrically connected to the second wire pattern 106 by the second connection member 142b which is a flip chip bonding member. Also, the memory semiconductor chips 140 may be electrically connected to each other through a third connection member 143b which is a conductive via.

Referring to FIG. 7, the stacking type USB memory device 1c includes a substrate 100c formed of a plurality of substrate members 109a, 109b, and 109c combined with each other when compared to the stacking type USB memory device 1 of FIG. 3. The substrate members 109a, 109b, and 109c may form a recess region 102c by combining each other. Also, a first wire pattern 104c may be optionally formed in the middle substrate member 109b, and the control semiconductor chip 120 may be electrically connected to the first wire pattern 104c by being mounted on the middle substrate member 109b.

Referring to FIG. 3 and FIGS. 5 through 7, it is understood that technical aspects described above may be applied by combining each other. For example, the first connection members 122, 122a, and 122b and the second sealing members 144, 144a, and 144b are examples, and thus, the present inventive concept is not limited thereto and includes all kinds of known conductive connection members. Also, the first connection members 122, 122a, and 122b and the second sealing members 144, 144a, and 144b may respectively include a combination of bonding wire, solder ball, bump, and flip chip bonding member, and the third connection member 143a and 143b may include a combination of bonding wire, solder ball, bump, and conductive via. For example, in the stacking type USB memory device according to an embodiment of the present inventive concept, the bonding wire of FIG. 3 may be the first connection member, and the solder ball of FIG. 5 or the flip chip bonding member of FIG. 6 may be the second connection member. Also, in this case, the third connection member may be the solder ball or the conductive via. Also, the substrate 100c having a multiple layer structure shown in FIG. 7 may be formed by combining the embodiments described above.

In the stacking type USB memory device 1 according to an embodiment of the present inventive concept, a passive electronic element and a control semiconductor chip are mounted in a recess region of a substrate and a memory semiconductor chip can be stacked on the recess region so as to overlap the recess region. Accordingly, the size of the stacking type USB memory device 1 can be reduced. Also, the passive electronic element, the control semiconductor chip, or both of them can be mounted so as to overlap an external wire pattern, and thus, the size of the stacking type USB memory device 1 can further be reduced. Also, the stacking type USB memory device 1 can provide improved high frequency characteristics, improved thermal stability, and high reliability.

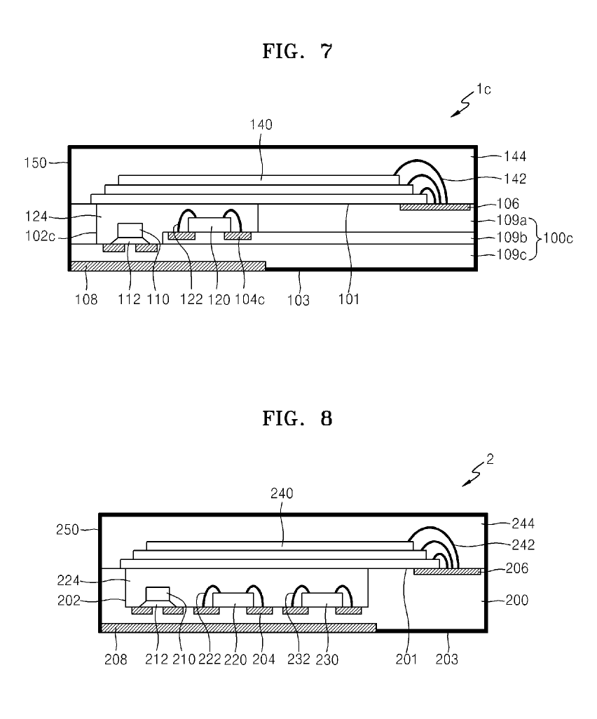

FIG. 8 is a cross-sectional view of a stacking type USB memory device 2 according to another embodiment of the present inventive concept.

Referring to FIG. 8, the stacking type USB memory device 2 includes a substrate 200, at least one passive electronic element 210, at least one control semiconductor chip 220, at least one functioning semiconductor chip 230, at least one memory semiconductor chip 240, and an external wire pattern 208. The passive electronic element 210, the control semiconductor chip 220 and the functioning semiconductor chip 230 are mounted in a recess region 201 of the substrate 200. The passive electronic element 210 is electrically connected to a first wire pattern 204 formed in the recess region 201 of the substrate 200 through a passive electronic element connection member 212. The control semiconductor chip 220 is electrically connected to the first wire pattern 204 formed in the recess region 201 of the substrate 200 through a first connection member 222. The functioning semiconductor chip 230 is electrically connected to the first wire pattern 204 formed in the recess region 201 of the substrate 200 through a second connection member 232. The memory semiconductor chip 240 is mounted on a first surface 201 of the substrate 200. In other words, the memory semiconductor chip 240 may be mounted on the recess region 201 of the substrate 200 so as to overlap the passive electronic element 210, the control semiconductor chip 220, the functioning semiconductor chip 230, or all of these elements, which are mounted in the recess region 202. The memory semiconductor chip 240 is electrically connected to a second wire pattern 206 formed on the substrate 200 by third connection member 242. The passive electronic element 210, the control semiconductor chip 220, and the functioning semiconductor chip 230 may be sealed by a first sealing member 224, and the memory semiconductor chip 240 is sealed by a second sealing member 244. Optionally, the stacking type USB memory device 2 may further include a case 250 to surround the substrate 200 and the second sealing member 244 by exposing at least a portion of the external wire pattern 208.

The stacking type USB memory device 2 according to another embodiment of the present inventive concept, the passive electronic element 210, the control semiconductor chip 220, and the functioning semiconductor chip 230 are mounted in a recess region 202 of the substrate 200, and the memory semiconductor chip 240 can be stacked on the recess region 202 so as to overlap the passive electronic element 210, the control semiconductor chip 220, the functioning semiconductor chip 230, or all of them. Accordingly, the size of the stacking type USB memory device 2 can be reduced. Also, the passive electronic element 210, the control semiconductor chip 220, the functioning semiconductor chip 230, or all of them can be mounted so as to overlap the external wire pattern 208, and thus, the size of the stacking type USB memory device 2 can further be reduced.

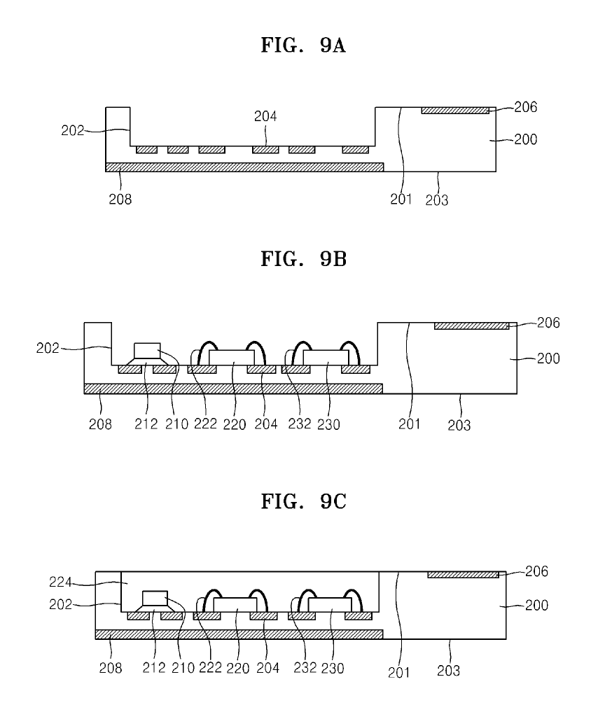

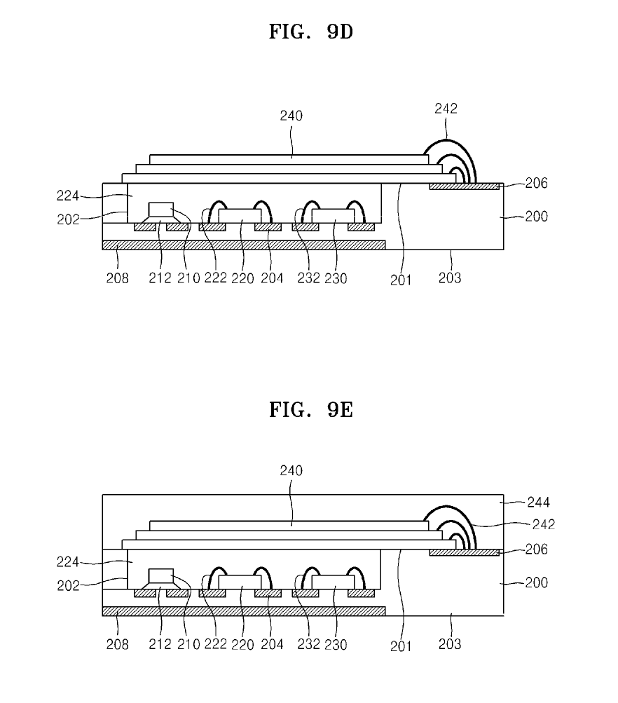

FIGS. 9A through 9E are cross-sectional views showing processes of fabricating the stacking type USB memory device 2 according to another embodiment of the present inventive concept.

Referring to FIG. 9A, a substrate 200 including a recess region 202 is provided. The substrate 200 includes a first wire pattern 204 formed in the recess region 202, a second wire pattern 206 formed on a first surface 201, and an external wire pattern 208 formed on a second surface 203 that faces the first surface 201.

The substrate 200 may be formed of epoxy resin, polyimide resin, bismaleimide triazine (BT) resin, flame retardant 4 (FR-4), FR-5, ceramic, silicon, or glass; however, these materials are examples, and thus, the materials according to the present inventive concept are not limited thereto. The substrate 200 may be a monolayer substrate or a substrate having a multi-layered structure of wire patterns. For example, the substrate 200 may be a single rigid substrate, a substrate formed by combining multiple rigid substrates, or a combined substrate in which thin flexible printed circuit boards (PCBs) and rigid substrates are combined. The multiple rigid substrates combined to each other or the PCBs that are combined to each other may respectively include wire patterns. Also, the substrate 200 may be a low temperature co-fired ceramic (LTCC) substrate. The LTCC substrate may be formed by stacking a plurality of ceramic layers and can include wire patterns therein. Also, the substrate 200 may be simultaneously formed with the recess region 202 using a molding method that uses a mold having a reversed shape to the recess region 202. Also, the recess region 202 may be formed by mechanically processing a portion of the substrate 200 or by chemically etching the substrate 200. Also, the recess region 202 may be formed by combining at least two substrate members (not showing). Also, more than two recess regions 202 may be formed in a single substrate 200.

As described above, the second wire pattern 206 is formed on the first surface 201 of the substrate 200 and the external wire pattern 208 is formed on the second surface 203 facing the first surface 201. Also, the first wire pattern 204 is formed in the recess region 202 of the substrate 200. The external wire pattern 208 is electrically connected to external devices. The external wire pattern 208 may correspond to the connection unit 26 of FIG. 1B, and may include, for example, a power line V_{BUS}, a ground line GND, and a pair of data lines D+ and D−. Although not shown, the first wire pattern 204, the second wire pattern 206, and the external wire pattern 208 may be electrically connected to each other through an electrical connection member, for example, conductive vias (not shown). Also, ad described above, the substrate 200 may be a multi-layered substrate that includes wire patterns therein, and the first wire pattern 204 and the second wire pattern 206 may be wire patterns formed in the substrate 200. Also, the first wire pattern 204, the second wire pattern 206, and the external wire pattern 208 may include a metal, for example, Cu, Al, Au, Ag, Pt, Ni, Pd, Ru, or an alloy of these metals. Also, the first wire pattern 204, the second wire pattern 206, and the external wire pattern 208 may be formed by stacking multiple layers, and a metal having a strong oxidation resistance, for example, Au can be coated on surfaces thereof; however, it is an example, and thus, the present invention is not limited thereto.

Referring to FIG. 9B, at least one passive electronic element 210, at least one control semiconductor chip 220, and at least one functioning semiconductor chip 230 are mounted in the recess region 202 of the substrate 200. The relative positions and the numbers of passive electronic elements 210 and the control semiconductor chips 220 are examples, and thus, the present invention is not limited thereto. For example, the passive electronic element 210, the control semiconductor chip 220, and the functioning semiconductor chip 230 may be respectively multiple numbers, and may be disposed in the recess region 202 in an arrangement different from that of shown in FIG. 9B. Also, the passive electronic element 210, the control semiconductor chip 220, and the functioning semiconductor chip 230 may be respectively mounted in a plurality of recess regions 202 (not shown) that are separated from each other.

The passive electronic element 210 may be electrically connected to the first wire pattern 204 through a passive electronic element connection member 212. The passive electronic element connection member 212 may be, for example, a solder. The passive electronic element 210 may be a resistance element, an inductor element, a capacitor element, or a switch element, but not limited thereto.

The control semiconductor chip 220 may be electrically connected to the first wire pattern 204 through a first connection member 222. The first connection member 222 may have a height that does not protrude from the height of the recess region 202 of the substrate 200. The control semiconductor chip 220 may be attached to the recess region 202 of the substrate 200 using an adhesion member (not shown) such as a liquid adhesive or an adhesive tape. The control semiconductor chip 220 may correspond to the control unit 24 of FIG. 1B, may control communications between the stacking type USB memory device 2 and the host 3, and may control the operation of programming, reading, and erasing of data in the memory semiconductor chip 240. Also, the control semiconductor chip 220 may be a semiconductor chip die or a semiconductor package.

The functioning semiconductor chip 230 may be electrically connected to the first wire pattern 204 through a second connection member 232. The second connection member 232 may have a height that does not protrude from the height of the recess region 202 of the substrate 200. The functioning semiconductor chip 230 may be attached to the recess region 202 of the substrate 200 using an adhesion member (not shown) such as a liquid adhesive or an adhesive tape. The functioning semiconductor chip 230 may correspond to the functioning unit 23 of FIG. 1B, and may be a WLAN control semiconductor chip or a SIM control semiconductor chip such as SIM or USIM. Also, the functioning semiconductor chip 230 may be a semiconductor chip die or a semiconductor package. The first connection member 222 and the second connection member 232 respectively may be a bonding wire, and the bonding wire may be formed of Au, Ag, Cu, Al, or an alloy of these metals. The bonding wire may be formed using a conventional forward folded loop mode method or a reverse loop mode method. Also, the first connection member 222 and the second connection member 232 respectively are depicted in a bonding wire as an example; however, the present invention is not limited thereto. For example, the first connection member 222 and the second connection member 232 respectively may be a solder ball, a flip-chip bonding member, a bump, a conductive via, or a combination of these materials. Another embodiment of the first connection member 222 and the second connection member 232 will be described later in detail.

Referring to FIG. 9C, a first sealing member 224 that buries the recess region 202 is formed. The first sealing member 224 seals the passive electronic element 210, the control semiconductor chip 220, and the functioning semiconductor chip 230. The first sealing member 224 may protect the passive electronic element 210, the control semiconductor chip 220, the functioning semiconductor chip 230, the passive electronic element connection member 212, the first connection member 222, and the second connection member 232 from an external environment. The passive electronic element 210, the control semiconductor chip 220, the functioning semiconductor chip 230, the first connection member 222, and the second connection member 232 may not protrude from the first sealing member 224. The first sealing member 124 may be an encapsulant material, for example, an epoxy resin or a silicon resin; however, the encapsulant material according to the present are not limited thereto. Also, the fabrication of the first sealing member 124 is optional, and thus, the fabrication process thereof may be omitted, and may be simultaneously formed with a second sealing member 244 which will be described later.

Referring to FIG. 9D, at least one memory semiconductor chip 240 is mounted on the first surface 201 of the substrate 200. The memory semiconductor chip 240 is positioned to stack overlapping with the recess region 202 where the passive electronic element 210, the control semiconductor chip 220, and the functioning semiconductor chip 230 are mounted. Thus, at least one of the passive electronic element 210, the control semiconductor chip 220, and the functioning semiconductor chip 230 may be overlapped with the memory semiconductor chip 240. The memory semiconductor chip 240 may be electrically connected to the second wire pattern 206 through a third connection member 242. The memory semiconductor chip 240 may be attached to the first surface 201 of the substrate 200 using an adhesive member (not shown) such as a liquid adhesive or an adhesive tape. The memory semiconductor chip 240 may correspond to the memory unit 22 of FIG. 1B, may be a data storing device, and may be a non-volatile memory such as an NAND flash memory, a PRAM, an RRAM, a FeRAM, or a MRAM. Also, the memory semiconductor chips 240 may have sizes identical or different from each other. Also, the memory semiconductor chip 240 may be a semiconductor die or a semiconductor package. The kind, number, size, stacking method, and stacking shape of the memory semiconductor chip 240 shown in FIG. 9D are examples, and thus, are not limited thereto.

The third connection member 242 may be a bonding wire, and the bonding wire may be formed of Au, Ag, Cu, Al, or an alloy of these metals. In FIG. 9D, the third connection member 142 is depicted as a bonding wire; however, it is an example, and thus, is not limited thereto. For example, the third connection member 242 may be a solder ball, a flip-chip bonding member, a bump, or a conductive via. Another embodiment of the third connection member 242 will be described later in detail.

Referring to FIG. 9E, a second sealing member 244 is formed to seal the memory semiconductor chip 240. The memory semiconductor chip 240 and the third connection member 242 may not protrude from the second sealing member 244. The second sealing member 244 may be an encapsulant material, for example, an epoxy resin or a silicon resin; however, it is an example, and thus, the encapsulant material according to the present are not limited thereto. The second sealing member 244 protects the substrate 200, the memory semiconductor chip 240, and the third connection member 242 from an external environment. The first sealing member 224 and the second sealing member 244 may be formed of an identical member or different members from each other. When the first sealing member 224 is not formed, the recess region 202 may be buried with the second sealing member 244, and accordingly, the passive electronic element 210, the control semiconductor chip 220, and the functioning semiconductor chip 230 may be sealed together with the memory semiconductor chip 240. As a result, the sum of heights of the substrate 200 and the second sealing member 244 is equal to the height of the connection unit 26 of FIG. 1B, and thus, may have a size that can be inserted into a receptacle (not shown) formed in the host 3 so that the connection unit 26 can be connected to the host 3.

Next, a case 250 may be formed to surround the substrate 200 and the second sealing member 244 by exposing at least a portion of the external wire pattern 208, and thus, the manufacture of the stacking type USB memory device 2 of FIG. 8 is completed. The case 250 may be formed of metal or polymer, and may protect the stacking type USB memory device 2 from external environment. In some cases, at least a portion of the case 250 may be omitted.

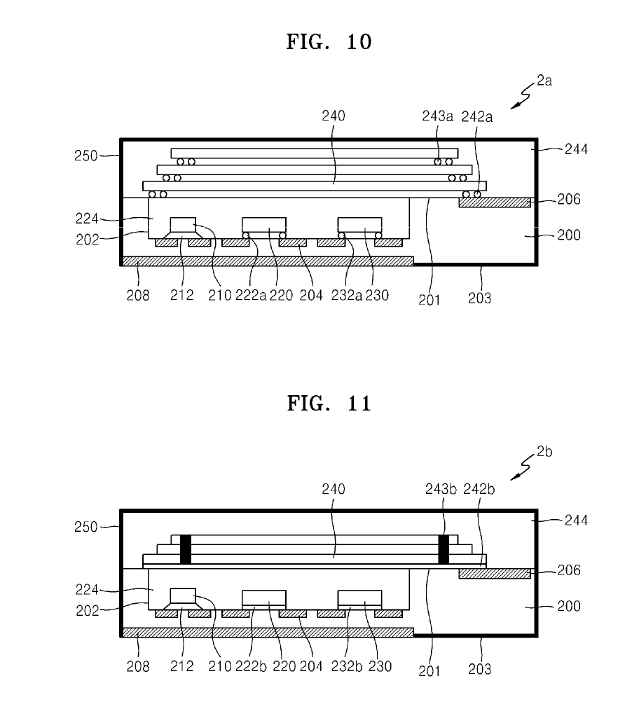

FIGS. 10 through 13 are cross-sectional views of stacking type USB memory devices 2a, 2b, and 2c according to an embodiment of the present inventive concept. For clarity of the present inventive concept, descriptions of elements which have described above will be omitted.

Referring to FIG. 10, the stacking type USB memory device 2a includes solder balls as a first connection member 222a, a second connection member 232a, and a third connection member 242a when compared to the stacking type USB memory device 2 of FIG. 8. Thus, the control semiconductor chip 220 and the functioning semiconductor chip 230 are electrically connected to the first wire pattern 204 respectively through the first connection member 222a and the second connection member 232a, which are solder balls. Also, the memory semiconductor chip 240 is electrically connected to the second wire pattern 206 through the third connection member 242a which is a solder ball. Also, the memory semiconductor chips 240 may be electrically connected to each other by a fourth connection member 243a which is a solder ball.

Referring to FIG. 11, the stacking type USB memory device 2b includes flip chip bonding members as a first connection member 222b, a second connection member 232b, and a third connection member 242b when compared to the stacking type USB memory device 2 of FIG. 8. Thus, the control semiconductor chip 220 and the functioning semiconductor chip 230 is electrically connected to the first wire pattern 204 respectively through the first connection member 222b and a second connection member 232b, which are flip chip bonding members. Also, the memory semiconductor chip 240 is electrically connected to the second wire pattern 206 through the third connection member 242b which is a flip chip bonding member. Also, the memory semiconductor chips 240 may be electrically connected to each other through a fourth connection member 243b which is a conductive via.

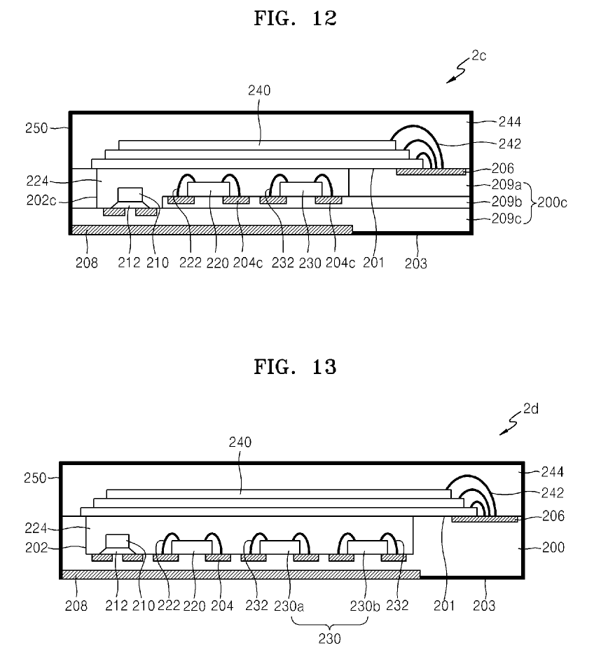

Referring to FIG. 12, the stacking type USB memory device 2c includes a substrate 200c in which a plurality of substrate members 209a, 209b, and 209c are combined with each other when compared to the stacking type USB memory device 2 of FIG. 8. The substrate members 209a, 209b, and 209c may form a recess region 202c by combining each other. Also, a first wire pattern 204c may be optionally formed in the middle substrate member 209b, and the control semiconductor chip 220 and/or the functioning semiconductor chip 230 may be electrically connected to the first wire pattern 204c by being mounted on the middle substrate member 209b.

Referring to FIG. 13, the stacking type USB memory device 2d includes both a WLAN semiconductor chip 230a and a SIM control semiconductor chip 230b as the functioning semiconductor chip 230. The WLAN semiconductor chip 230a and the SIM control semiconductor chip 230b may be mounted in the same recess region 202 or recess regions 202 different from each other.

Referring to FIG. 8 and FIGS. 10 through 13, it is understood that technical aspects described above may be applied by combining each other. For example, the first connection members 222, 222a, and 222b, the second connection members 232, 232a, and 232b, and the third connection members 242, 242a, and 242b are examples, and thus, the present inventive concept is not limited thereto and includes all kinds of known conductive connection members. Also, the first connection members 222, 222a, and 222b, the second connection members 232, 232a, and 232b, and the third connection members 242, 242a, and 242b may respectively include a combination of bonding wire, solder ball, bump, and flip chip bonding member, and the fourth connection members 243a and 243b may include a combination of bonding wire, solder ball, bump, and conductive via. For example, in the stacking type USB memory device according to an embodiment of the present inventive concept, the bonding wire of FIG. 8 may be the first connection member or the second connection member, and the solder ball of FIG. 10 or the flip chip bonding member of FIG. 11 may be the third connection member. Also, in this case, the fourth connection member may be the solder ball or the conductive via. Also, the substrate 200c having a multiple layer structure shown in FIG. 12 may be formed by combining the embodiments described above. Also, in the embodiments described above, as shown in FIG. 13, the WLAN semiconductor chip 230a and the SIM control semiconductor chip 230b may be included as the functioning semiconductor chip 230.

In the stacking type USB memory device 2 according to an embodiment of the present inventive concept, a passive electronic element, a control semiconductor chip, and a functioning semiconductor chip are mounted in a recess region of a substrate and a memory semiconductor chip can be stacked on the recess region so as to overlap the recess region. Accordingly, the size of the stacking type USB memory device 2 can be reduced. Also, the passive electronic element, the control semiconductor chip, the functioning semiconductor chip, or all of them can be mounted so as to overlap an external wire pattern, and thus, the size of the stacking type USB memory device 2 can further be reduced. Also, the stacking type USB memory device 2 can provide multiple functions such as a WLAN function and a SIM function together with the memory function, and can provide improved high frequency characteristics, improved thermal stability, and high reliability.

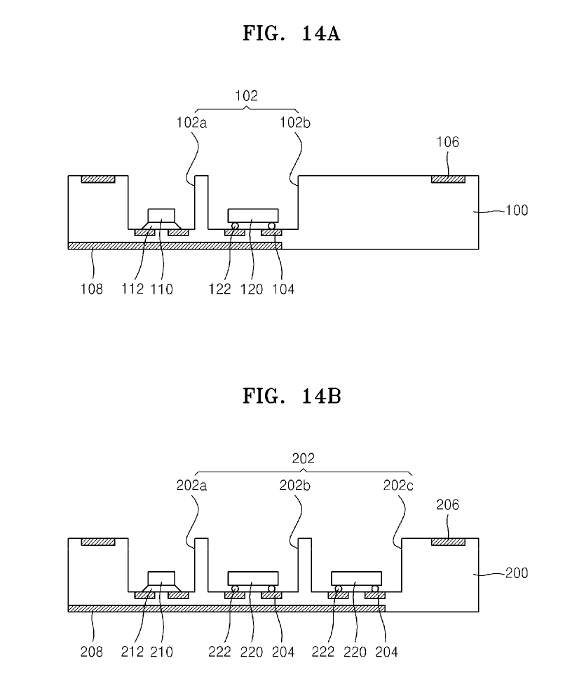

FIGS. 14A and 14B are cross-sectional views of substrates having a plurality of recess regions according to another embodiment of the present inventive concept.

Referring to FIG. 14A, the substrate 100 includes a plurality of recess regions 102a and 102b. A passive electronic element 110 and a control semiconductor chip 120 may be mounted in the recess regions 102a and 102b different from each other. Referring to FIG. 14B, a substrate 200 includes a plurality of recess regions 202a, 202b, and 202c. A passive electronic element 110, a control semiconductor chip 120, and a functioning semiconductor chip may be mounted in the recess regions 202a, 202b, and 202c different from each other. These are examples, and number, size, shape, and/or position of the recess region according to the present inventive concept are not limited thereto.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A stacking type universal serial bus (USB) memory device comprising:
a substrate that includes a recess region;
at least one passive electronic element mounted in the recess region;
at least one control semiconductor chip mounted in the recess region;
at least one semiconductor memory chip mounted on a first surface of the substrate so as to overlap the at least one passive electronic element, the at least one control semiconductor chip, or both of them; and
an external wire pattern formed on a second surface of the substrate facing the first surface thereof.

2. The stacking type USB memory device of claim 1, wherein the recess region further comprises a first wire pattern therein, and the at least one control semiconductor chip is electrically connected to the first wire pattern through a first connection member.

3. The stacking type USB memory device of claim 2, wherein the first connection member comprises at least one selected from the group consisting of a bonding wire, a solder ball, a flip-chip bonding member, a bump, or a conductive via.

4. The stacking type USB memory device of claim 2, wherein the first connection member has a height so as not to protrude from the height of the recess region.

5. The stacking type USB memory device of claim 1, wherein the substrate further comprises a second wire pattern on the first surface thereof, and the at least one semiconductor memory chip is electrically connected to the second wire pattern through a second connection member.

6. The stacking type USB memory device of claim 5, wherein the second connection member comprises at least one selected from the group consisting of a bonding wire, a solder ball, a bump, or a conductive via.

7. The stacking type USB memory device of claim 1, wherein the substrate comprises a plurality of recess regions.

8. The stacking type USB memory device of claim 7, wherein the at least one passive electronic element and the at least one control semiconductor chip are mounted in the recess regions different from each other.

9. The stacking type USB memory device of claim 1, wherein the substrate has a multi-layered structure.

10. The stacking type USB memory device of claim 1, wherein the semiconductor memory chip is a semiconductor die or a semiconductor package.

11. A stacking type USB memory device of claim comprising:
a substrate that comprises at least one recess region;
at least one passive electronic element mounted in the recess region;
at least one control semiconductor chip mounted in the recess region;
at least one functional semiconductor chip mounted in the recess region
at least one semiconductor memory chip mounted on a first surface of the substrate so as to overlap the passive electronic element, the control semiconductor chip, the functional semiconductor chip, or all of them; and
an external wire pattern formed on a second surface of the substrate facing the first surface thereof.

12. The stacking type USB memory device of claim 11, wherein the recess region further comprises a first wire pattern therein, and the at least one control semiconductor chip, the at least one functional semiconductor chip, and both of them are electrically connected to the first wire pattern through a first connection member.

13. The stacking type USB memory device of claim 12, wherein the first connection member comprises at least one selected from the group consisting of a bonding wire, a solder ball, a bump, a flip-chip bonding member, or a conductive via.

14. The stacking type USB memory device of claim 12, wherein the first connection member has a height so as not to protrude from the height of the recess region.

15. The stacking type USB memory device of claim 11, wherein the substrate further comprises a second wire pattern on the first surface thereof, and the at least one semiconductor memory chip is electrically connected to the second wire pattern through a third connection member.

16. The stacking type USB memory device of claim 15, wherein the third connection member comprises at least one selected from the group consisting of a bonding wire, a solder ball, a flip-chip bonding member, a bump, and a conductive via.

17. The stacking type USB memory device of claim 11, wherein the at least one functional semiconductor chip comprises a WLAN (wireless local area network) functional semiconductor chip and a SIM (subscriber identity module) functional semiconductor chip.

18. The stacking type USB memory device of claim 11, wherein the at least one passive electronic element, the at least one control semiconductor chip, and the at least one functional semiconductor chip are mounted in the recess regions different from each other.

19. The stacking type USB memory device of claim 11, wherein the substrate has a multi-layered structure.

20. The stacking type USB memory device of claim 11, wherein the at least one semiconductor memory chip is a semiconductor die or a semiconductor package.
